(19) United States
(12) Patent Application Publication
(10) Pub. No.: US 2009/0114197 A1
(43) Pub. Date: May 7, 2009

(54) NITROUS OXIDE SYSTEM HAVING HIGH PRESSURE AUXILIARY GAS TANK

(75) Inventor: Thomas A. Darnell, Lawrence, KS (US)

Correspondence Address: HOVEY WILLIAMS LLP, 10801 Mastin Blvd., Suite 1000, Overland Park, KS, 66210, US

(73) Assignee: DARNELL, INC. OF KANSAS, Lawrence, KS (US)

(21) Appl. No.: 11/933,867

(22) Filed: Nov. 1, 2007

(51) Int. Cl. F02B 43/10; F02M 25/10

(52) U.S. Cl. 123/585; 123/445

(57) ABSTRACT

A gas-capped nitrous oxide system configured to supply nitrous oxide to a combustion engine comprises a nitrous bottle with a liquid and vapor mixture of pressurized nitrous oxide, an auxiliary bottle with pressurized capping gas, and a variable-flow regulator that fluidly interconnects the bottles. The auxiliary bottle and regulator cooperatively supply capping gas to keep the liquid portion of the nitrous oxide in the liquid phase as the nitrous oxide evacuates the nitrous bottle. The regulator is configured to supply a substantially constant discharge pressure while varying the capping gas flow rate so that the system provides a substantially constant nitrous oxide flow rate to the engine.

### BACKGROUND

1. Field

The present invention relates generally to nitrous oxide systems that provide a flow of oxygen to an internal combustion engine. More specifically, embodiments of the present invention concern a gas-capped nitrous oxide system that provides a substantially uniform flow of nitrous oxide.

2. Discussion of Prior Art

Conventional nitrous oxide systems are configured to inject oxygen into an internal combustion engine at a rate that is substantially higher than the engine could otherwise draw from ambient in a normally aspirated manner. Consequently, an engine supplied with oxygen from a nitrous oxide system is able to generate greater horsepower than the normally aspirated engine, provided that a correspondingly higher rate of fuel is also provided. Prior art nitrous oxide systems include a pressure vessel with compressed nitrous oxide stored therein, with part of the nitrous oxide being in a liquid phase and another part being in a vapor phase. The prior art systems are configured to encourage the flow of the liquid phase portion out of the pressure vessel rather than the vapor phase portion. Thus, the liquid phase portion contained in the vessel decreases rapidly and reduces the internal vessel pressure, which results in at least some of the remaining part of the liquid phase portion vaporizing in order to fill the entire vessel volume. Prior art systems often include a bottle heater that is configured to heat the nitrous oxide and raise the vessel pressure. It is also known in the prior art to fluidly connect the nitrous vessel with another vessel that includes a pressurized capping gas, with the capping gas being configured to flow into the nitrous vessel and raise the vessel pressure to support the flow of nitrous oxide out of the nitrous vessel.

Prior art nitrous oxide systems are problematic and suffer from various undesirable limitations. Prior art nitrous oxide systems fail to maintain the liquid phase portion of the nitrous oxide in the liquid phase during operation. Furthermore, the prior art systems fail to provide a substantially constant flow rate of nitrous oxide during the entire time that the nitrous oxide is being evacuated from the nitrous vessel. For instance, as a bottle of nitrous oxide supplies the liquid phase portion, at least some of the liquid phase portion remaining in the bottle vaporizes and thereby expands to fill the bottle. As the vapor phase portion becomes larger, vapor is more likely to become entrained within the liquid phase portion. Moreover, the entrained vapor is more likely to enter the nitrous flow to the engine as the amount liquid phase portion becomes smaller. The entrainment of vapor in the nitrous flow reduces the mass flow rate of nitrous oxide to the engine, which can result in a non-stoichiometric air-to-fuel ratio in the engine and negatively impact engine performance.

### SUMMARY

The present invention provides a nitrous oxide injection system that does not suffer from the problems and limitations of the prior art nitrous oxide injection systems set forth above.

A first aspect of the present invention concerns a nitrous oxide injection system operable to supply an enhanced oxygen flow to a combustion engine. The system broadly includes a nitrous bottle, an auxiliary bottle, and a capping gas regulator. The nitrous bottle contains compressed nitrous oxide configured to provide the enhanced oxygen flow, with at least part of the nitrous oxide being in a liquid phase. The auxiliary bottle contains a compressed oxygenic capping gas. The capping gas regulator fluidly interconnects the bottles and regulates flow of capping gas from the auxiliary bottle to the nitrous bottle so that the capping gas flow maintains a total energy within the nitrous bottle while the nitrous bottle supplies the oxygen flow to thereby keep substantially all of the liquid phase portion in the liquid phase as the nitrous oxide evacuates the nitrous bottle.

A second aspect of the present invention concerns a nitrous oxide injection system operable to supply enhanced oxygen flow to a combustion engine. The system broadly includes a nitrous bottle, an auxiliary bottle, and a variable-flow pressure regulator. The nitrous bottle contains compressed nitrous oxide configured to provide the enhanced oxygen flow, with at least part of the nitrous oxide being in a liquid phase. The auxiliary bottle contains a compressed capping gas. The variable-flow pressure regulator fluidly interconnects the bottles and regulates flow of capping gas from the auxiliary bottle to the nitrous bottle. The variable-flow pressure regulator is operable to discharge the capping gas flow at a substantially constant pressure while the nitrous bottle supplies the oxygen flow to maintain substantially all of the liquid phase portion in the liquid phase. The pressure regulator is operable to vary the capping gas flow so that the system provides a substantially constant nitrous oxide flow rate from the nitrous bottle until all of the liquid phase portion is evacuated.

A third aspect of the present invention concerns a method of injecting nitrous oxide from a nitrous bottle into a combustion engine, with at least part of the nitrous oxide being in a liquid phase. The method includes the steps of fluidly connecting a capping gas bottle to the nitrous bottle; opening the nitrous bottle to permit the flow of nitrous oxide into the engine; and transmitting oxygenic capping gas from the capping gas bottle to the nitrous bottle while supplying the nitrous oxide to the engine, including the step of maintaining an amount of total energy within the nitrous bottle while the nitrous bottle supplies the oxygen flow so that substantially all of the liquid phase portion is maintained in the liquid phase as the contained nitrous oxide evacuates the nitrous bottle.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a partly schematic fragmentary view of a nitrous oxide-injected engine constructed in accordance with a preferred embodiment of the present invention, with the nitrous oxide-injected engine including an internal combustion engine and a nitrous oxide injection system;

FIG. 2 is a fragmentary front perspective view of the nitrous oxide injection system shown in FIG. 1, showing a nitrous bottle assembly with a nitrous oxide bottle partly sectioned to show the bottle interior and a nitrous valve, and gas capping assembly including a capping gas bottle, a variable-flow regulator, and fluid lines that fluidly connect the nitrous valve and regulator;

FIG. 3 is a rear perspective view of the nitrous oxide injection system shown in FIGS. 1 and 2;

FIG. 4 is a plan view of the nitrous oxide injection system shown in FIGS. 1-3;

FIG. 5 is a fragmentary cross-sectional view of the nitrous oxide injection system taken along line 5-5 in FIG. 4;

FIG. 5a is an enlarged fragmentary cross-sectional view of the nitrous oxide injection system shown in FIG. 5, showing a check valve and quick connect fitting fluidly connected to one another, with the check valve in an open position;

FIG. 6 is a fragmentary cross-sectional view of the nitrous oxide injection system taken along line 6-6 in FIG. 4;

FIG. 7 is a fragmentary cross-sectional view of the nitrous oxide injection system taken along line 7-7 in FIG. 4, showing the variable-flow regulator deactivated and a variable-size orifice in an open condition;

FIG. 8 is a fragmentary cross-sectional view of the nitrous oxide injection system as shown in FIG. 7, showing the variable-flow regulator in an open condition and the variable-size orifice in a closed condition;

FIG. 9 is a fragmentary cross-sectional view of the nitrous oxide injection system taken along line 9-9 in FIG. 4; and

FIG. 10 is a fragmentary cross-sectional view of the nitrous oxide injection system as shown in FIG. 9, showing the variable-flow regulator activated and the variable-size orifice in the open condition so that the regulator discharges a capping gas flow, and showing a fill valve in a closed position;

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

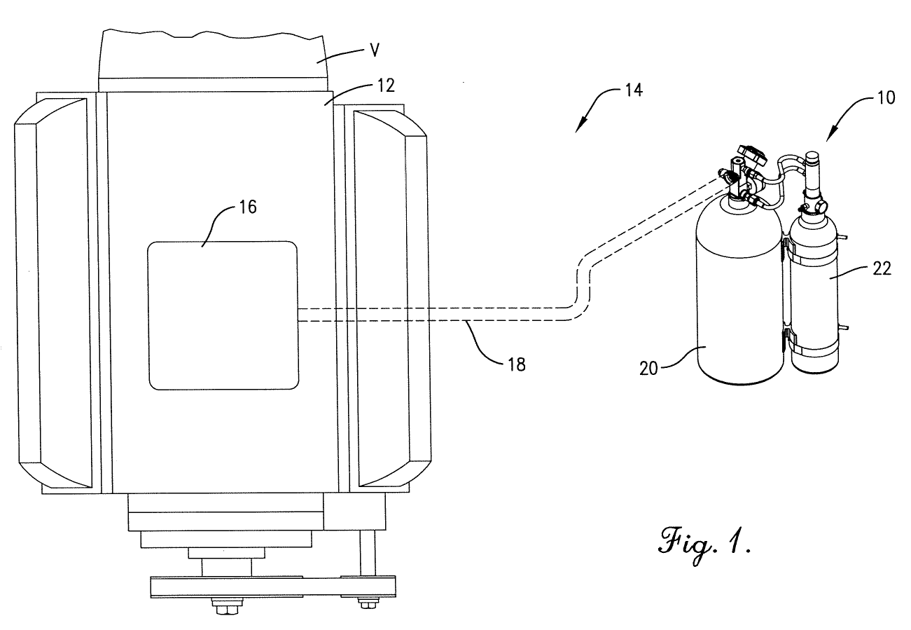

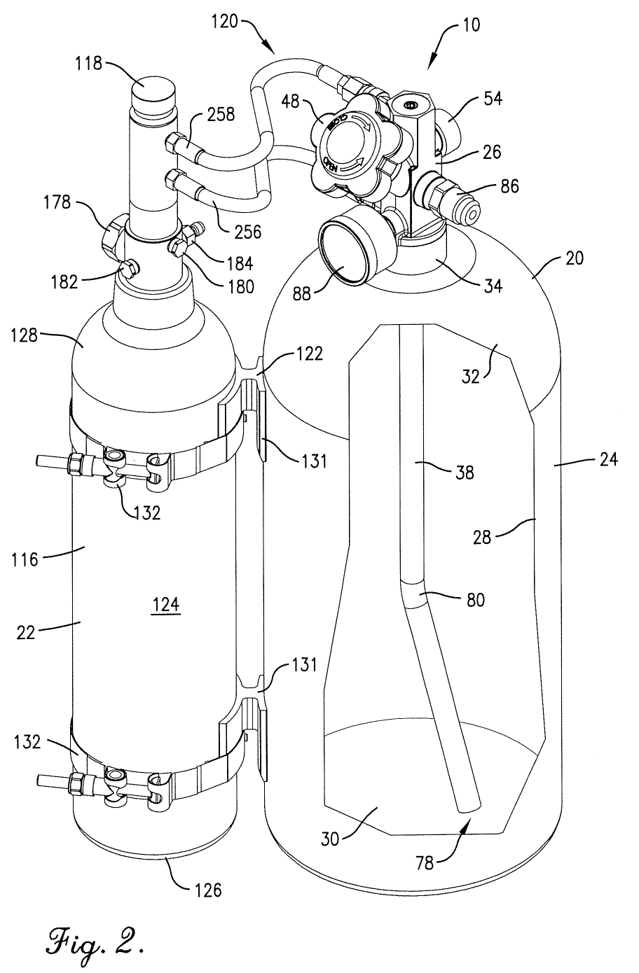

Turning initially to FIGS. 1 and 2, a nitrous oxide injection system 10 is fluidly connected to an internal combustion engine 12 of a vehicle V to provide nitrous-injection. Specifically, the injection system 10 is fluidly connected to an intake manifold 16 of the engine 12 by a conduit 18. While the illustrated vehicle V is an automobile, the principles of the present invention are applicable to other types of vehicles, such as a powered watercraft, a motorcycle, or an aircraft. The illustrated injection system 10 preferably injects substantially only nitrous oxide into the engine 12 to support combustion. However, as will be discussed further, it is also within the scope of the present invention where the injection system 10 introduces another fluid, i.e., a capping gas, into the engine 12 that serves to maintain the nitrous oxide at a desired pressure. Furthermore, the capping gas, e.g., high pressure air (HPA), may be operable to support combustion. While the injection system 10 preferably only introduces a combustion-supporting capping fluid, e.g., nitrous oxide or HPA, it is also possible with certain aspects of the present invention where the injection system 10 utilizes some fluid that does not support combustion, i.e., an inert fluid such as nitrogen. The injection system 10 broadly includes a nitrous bottle assembly 20 and a gas capping assembly 22.

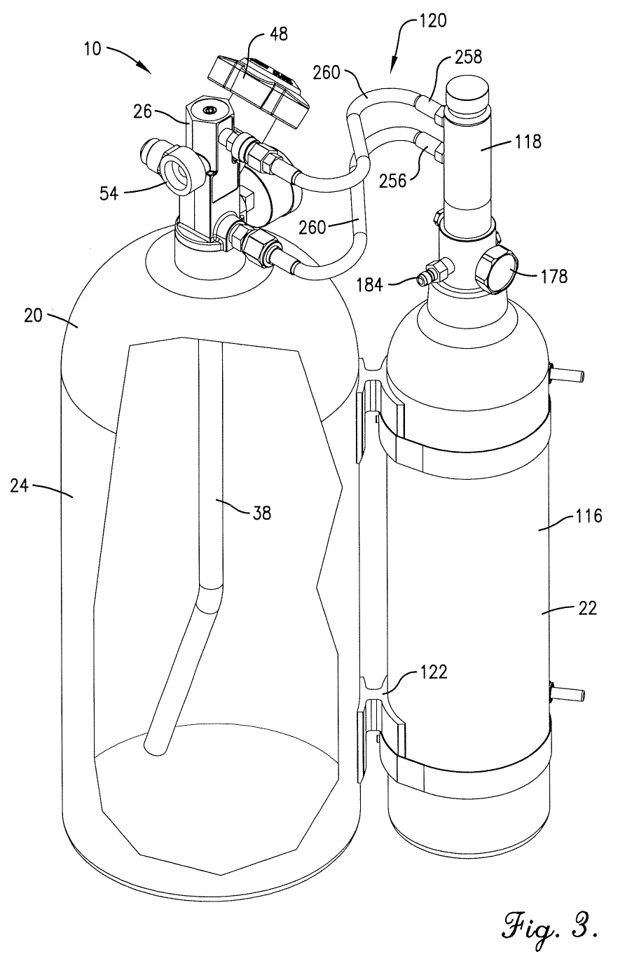

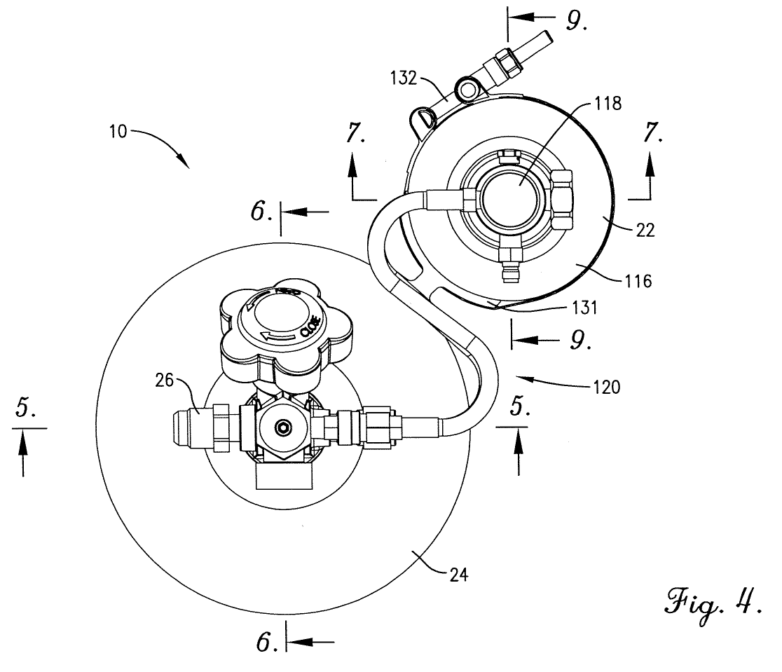

Turning to FIGS. 2-6, the nitrous bottle assembly 20 includes a nitrous bottle 24 and a nitrous valve assembly 26 fluidly connected to the nitrous bottle 24 to control fluid flow into and out of the nitrous bottle 24. The illustrated nitrous bottle 24 is entirely conventional and preferably comprises a substantially unitary pressure vessel that includes a cylindrical sidewall 28 and opposite endwalls 30,32. Endwall 32 includes an internally threaded nipple 34 that is sealingly attached to a remainder of the endwall 32 and is configured to receive the nitrous valve assembly 26 as will be discussed further. The nitrous bottle 24 is operable to contain compressed nitrous oxide operable to be supplied to engine 12. The nitrous bottle 24 is also configured to receive compressed capping gas from the assembly 22 as will be discussed in greater detail.

The illustrated nitrous bottle 24 is preferably manufactured from aluminum. However, the principles of the present invention are also applicable where the bottle 24 is manufactured from other materials, such as metallic materials, composite materials, e.g., carbon or fiberglass, or a combination of materials. The nitrous bottle 24 is preferably DOT certified. The illustrated bottle 24 is preferably an SCBA cylinder model manufactured by Luxfer Gas Cylinders, USA, 3016 Kansas Avenue, Riverside, Calif. 92507. More preferably, bottle 24 is sized to hold predetermined amounts of nitrous oxide as depicted in Table 1:

TABLE 1

| Amount of N2O (pounds) | Bottle Volume (cubic inches) |
|---|---|
| 5 | 203.5 |
| 10 | 407 |
| 15 | 530 |
| 20 | 815 |

However, the principles of the present invention are applicable where other amounts of nitrous oxide are stored in bottle 24 or whether other bottle sizes are used. When storing pressurized nitrous oxide in a bottle, DOT regulations require that at least 28% of the bottle volume must include nitrous oxide vapor, with the remaining 72% (or less) of the bottle volume containing liquid. For the above-referenced ten (10) pound bottle in Table 1, about 9.5 pounds mass of liquid nitrous oxide is contained in the bottle, with about 0.5 pounds mass of nitrous oxide being in the vapor phase. Preferably, the bottle 24 is also configured to hold nitrous oxide up to a pressure in the range of about 700 psi to about 1300 psi. As will be described further, the bottle 24 is preferably filled with nitrous oxide to a fill pressure of about 1100 psi.

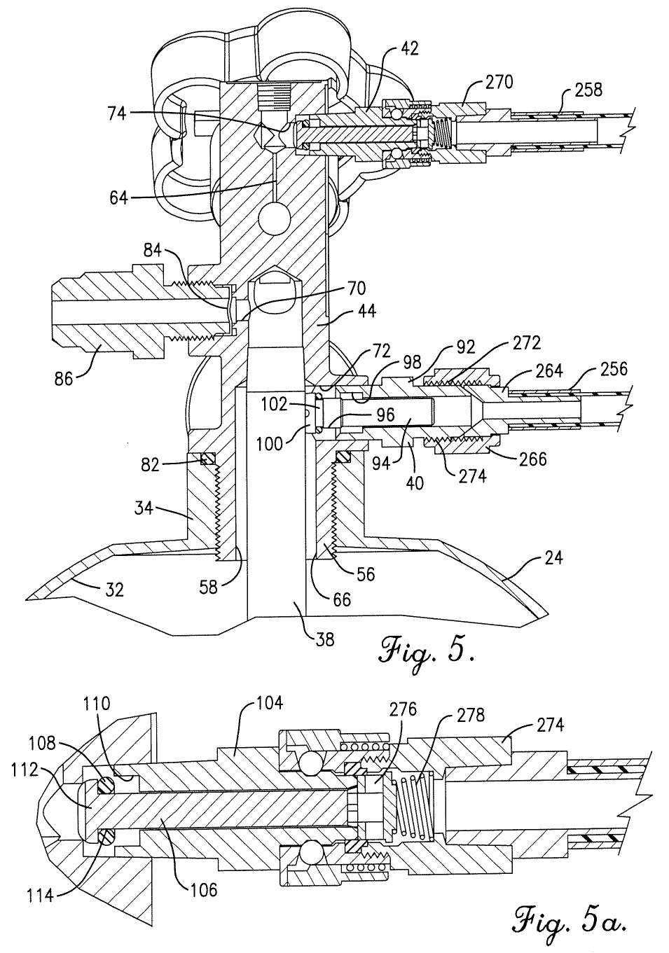

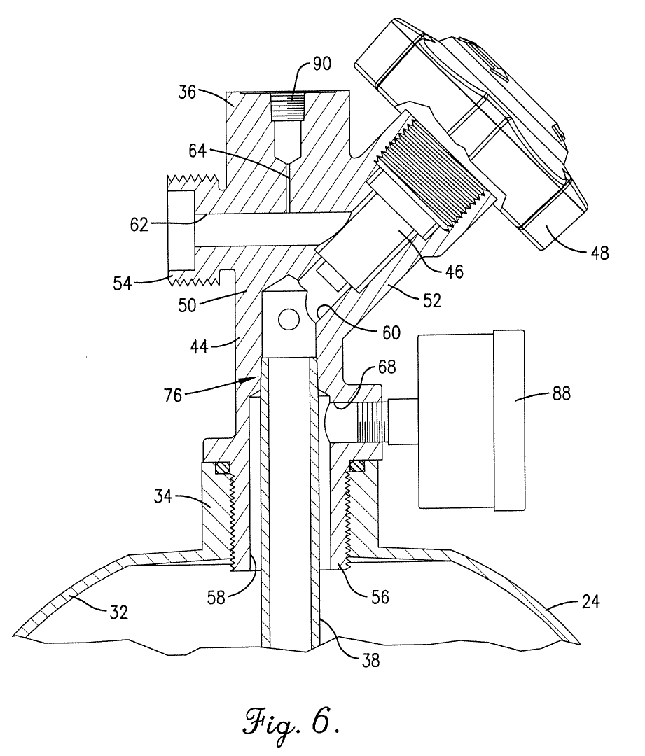

Turning to FIGS. 5 and 6, the nitrous valve assembly 26 includes a nitrous valve 36, a siphon tube 38, a gas supply check valve 40, and a control check valve 42. As will be discussed further, the nitrous valve assembly 26 controls the discharge of nitrous oxide from the nitrous bottle 24 and also controls the introduction of capping gas into the nitrous bottle 24. The nitrous valve 36 includes a valve manifold 44, a movable valve element 46, and a valve handle 48. The valve manifold 44 is substantially unitary and includes a body 50 that presents a manifold axis, an angled valve nipple 52, a supply nipple 54, and a lowermost bottle nipple 56. The valve manifold 44 presents a central bore 58 that extends partly along the manifold axis and extends through the bottle nipple 56, a valve bore 60 that extends through the valve nipple 52 and intersects the central bore 58, and a transverse bore 62 that extends through the supply nipple 54 and intersects the valve bore 60. The valve manifold 44 also presents a bleed bore 64 that extends axially to intersect the transverse bore 62. The valve manifold 44 further presents a bottle port 66 that fluidly communicates with the central bore 58, a gauge port 68 that fluidly communicates with the central bore 58, a discharge port 70 that fluidly communicates with the central bore 58, a gas supply port 72 that fluidly communicates with the transverse bore 62, and a bleed port 74 that fluidly communicates with the bleed bore 64.

The siphon tube 38 comprises an elongated tubular body with opposite tube ends 76,78 and a bend 80 spaced between the ends 76,78. The tube 38 is positioned with the end 76 secured within the central bore 58 and extending through the bottle nipple 56 so that the tube 38 and bottle nipple 56 cooperatively form a valve annulus.

The valve manifold 44 and siphon tube 38 are secured to the nitrous bottle 24 by extending the tube end 78 through the threaded nipple 34 and threading the bottle nipple 56 into the threaded nipple 34 until the manifold 44 and nitrous bottle 24 sealingly engage one another. Specifically, the manifold 44 and nitrous bottle 24 cooperatively form an O-ring gland with O-ring 82 being received therein. The siphon tube 38 extends downwardly from the nipple 34 with the tube end 78 being spaced adjacent the endwall 30.

The valve element 46 is received within the valve bore 60 to control the flow of nitrous oxide out of the nitrous bottle 24. Specifically, the movable valve element 46 is positioned within the valve bore 60 and is shiftable between open and closed positions by the valve handle 48.

The nitrous valve 36 further includes a burst disk 84 secured within the discharge port 70 by a fitting 86. The burst disk 84 is operable to rupture in response to an overpressure condition within the nitrous bottle 24 in order to prevent the bottle 24 or valve 36 from mechanically failing. While the illustrated burst disk 84 ruptures at about 3000 psi, it is also within the scope of the present invention where the disk 84 ruptures at a pressure greater than or less than 3000 psi.

The nitrous valve 36 also includes a pressure gauge 88 fluidly connected to the gauge port 68. In the usual manner, the pressure gauge 88 is operable to sense the internal bottle pressure and provide an indication of that pressure. A plug 90 is threaded into the bleed port 74. The preferred nitrous valve 36 is an NOS model valve manufactured by Holley Performance Products of Bowling Green, Ky.

As will be discussed in greater detail, the gas supply check valve 40 is configured to permit the flow of capping gas into the nitrous bottle 24 while restricting flow of nitrous oxide through the gas supply port 72. The gas supply check valve 40 includes a valve fitting 92, a piston plug 94, and an O-ring 96. The valve fitting 92 presents a countersunk bore 98 that receives the piston plug 94. The piston plug 94 is preferably unitary and includes a plug head 100 that presents an O-ring gland 102 that receives the O-ring 96. The gas supply check valve 40 is attached to the manifold 44 and received within the gas supply port 72 so that the check valve 40 fluidly communicates with the central bore 58. The gas supply check valve 40 is also oriented so that the plug head 100 is positioned within the gas supply port 72. The piston plug 94 is shiftable into and out of the valve fitting 92 between open and closed positions. In the closed position (not shown), the O-ring 96 and piston plug 94 cooperatively seal the bore 98. In the open position, the piston plug 94 shifts inwardly relative to the manifold 44 until the siphon tube 38 contacts the plug head 100.

The valve fitting 92 and piston plug 94 are preferably manufactured from stainless steel in order to prevent corrosion. However, it is also within the scope of the present invention to make the valve fitting 92 and piston plug 94 with other materials, such as other types of non-corrosive materials. The O-ring 96 is preferably made from a polyurethane material so that the O-ring resists chemical attack by nitrous oxide. For example, nitrile rubber, a commonly used O-ring material, chemically interacts with nitrous oxide. The principles of the present invention are equally applicable where a material other than polyurethane is used in O-ring 96.

By preventing nitrous oxide flow through the port, the check valve 40 serves to prevent any inadvertent release of nitrous oxide into ambient, e.g., by rupture of the capping gas bottle. In this manner, the system 10 satisfies NHRA regulations by limiting venting of nitrous oxide and is operable to save nitrous oxide if the capping gas assembly 22 fails. The check valve 40 is therefore preferred but not required. Furthermore, the check valve 40 can be alternatively configured, if desired, without departing from the scope of the present invention.

Turning to FIGS. 5 and 5a, the control check valve 42 is operable to permit the flow of nitrous oxide to the gas capping assembly 22 for regulating the flow of capping gas as will be discussed further. The control check valve 42 includes a valve fitting 104, a piston plug 106, and an O-ring 108. The valve fitting 104 presents a countersunk bore 110 that receives the piston plug 106. The piston plug 106 is preferably unitary and includes a plug head 112 that presents an O-ring gland 114 that receives the O-ring 108. The control check valve 42 is preferably manufactured from materials similar to those used in the check valve 40. The control check valve 42 is attached to the manifold 44 and received within the bleed port 74 so that the check valve 42 fluidly communicates with the bleed bore 64. The control check valve 42 is also oriented so that the plug head 112 is positioned within the bleed port 74. The piston plug 106 is shiftable into and out of the valve fitting 104 between open and closed positions. In the closed position (not shown), the O-ring 108 and piston plug 106 cooperatively seal the bore 110. In the open position, the piston plug 106 shifts inwardly relative to the manifold 44 until the manifold 44 contacts the plug head 112. While the illustrated check valve 42 is preferred, the principles of the present invention are applicable where another type of valve is used to selectively provide fluid communication to the bleed port 74.

Turning again to FIGS. 2-6, the nitrous bottle 24, aside from fluid received from the gas capping assembly 22, preferably contains and provides compressed nitrous oxide. However, the principles of the present invention are equally applicable where the bottle 24 includes another oxygenic fluid that supports combustion. The nitrous bottle 24 is operable to provide nitrous oxide to the engine 12 when the valve 36 is opened by turning the valve handle 48. In the usual manner, the opened valve 36 permits compressed nitrous oxide to flow through siphon tube 38, through central bore 58, then through the transverse bore 62, then through conduit 18 to the intake manifold 16. While the internal pressure of the bottle 24 is significantly greater than the manifold pressure, nitrous oxide will continue to flow out of the bottle to the intake manifold 16, e.g., nitrous oxide will continue to flow until the nitrous oxide is consumed.

Prior to use, the bottle 24 is preferably filled with nitrous oxide, so that nearly all of the nitrous oxide is in a liquid phase. Any remaining nitrous oxide is in a vapor phase, with the vapor portion being positioned above the liquid portion and forming a vapor dome. More preferably, to meet DOT requirements, the bottle 24 includes at least 28% nitrous oxide vapor by volume. The siphon tube 38 preferably extends into the bottle 24 so that the tube end 78 is positioned adjacent the lowest point of the liquid portion of the nitrous oxide. In this manner, the liquid portion is generally discharged prior to the vapor portion.

Turning to FIGS. 2, 3, and 7-10, the capping gas assembly 22 broadly includes a capping gas bottle 116, a regulator assembly 118, lines 120, and bracket assembly 122. As will be discussed in greater detail, the capping gas assembly 22 is fluidly connected to the nitrous bottle assembly 20 to supply capping gas to the nitrous bottle 24 so that the injection system 10 provides a uniform flow of nitrous oxide to the engine 12.

The illustrated bottle 116 is conventional and preferably comprises a substantially unitary pressure vessel that includes a cylindrical sidewall 124 and opposite endwalls 126,128. Endwall 128 includes an internally threaded nipple 130 that is sealingly attached to a remainder of the endwall 128 and is configured to receive the regulator assembly 118 as will be discussed further. The capping gas bottle 116 is operable to contain compressed capping gas therein, such as compressed nitrous oxide, Nitrox, or high pressure air (HPA) as will be discussed in greater detail.

The illustrated capping gas bottle 116 is preferably manufactured with an inner aluminum shell and an outer composite shell. However, the principles of the present invention are also applicable where the bottle 116 is manufactured from other materials, such as other metallic materials. The nitrous bottle 116 is preferably DOT certified. More preferably, the illustrated bottle 116 is an SCBA cylinder model, part number L 17A-6 manufactured by Luxfer Gas Cylinders, USA, 3016 Kansas Avenue, Riverside, Calif. 92507. Preferably, bottle 116 is sized to hold predetermined amounts of capping gas as depicted in Table 2:

TABLE 2
Bottle Volume (cubic inches)

60
114
148
230

However, the principles of the present invention are applicable where other amounts of capping gas are stored in bottle 116 or whether other bottle sizes are used. As will be discussed further, the bottle 116 is preferably sized relative to the bottle 24 in order to provide a uniform flow of nitrous oxide from the injection system 10 at a substantially constant flow rate. Preferably, the bottle 116 is also configured to hold capping gas up to a pressure in the range of about 2000 psi to about 6000 psi. More preferably, the bottle 116 is configured to hold capping gas up to a pressure of about 4500 psi. However, the principles of the present invention are applicable where the bottle is alternatively sized or configured to hold fluid at alternative pressures.

The bottle 116 is preferably mounted directly to the bottle 24 by the bracket assembly 122. However, it is within the ambit of the present invention where the bottles 24,116 are indirectly mounted to one another, i.e., where each bottle 24,116 is mounted individually to a structural member of an automobile. The bracket assembly 122 includes mounts 131, gas bottle clamps 132 that secure the bottle 116 to the mounts 130, and nitrous bottle clamps (not shown) that secure the bottle 24 to the mounts 130.

The regulator assembly 118 is operable to regulate the flow of capping gas from the capping gas bottle 116 to the nitrous bottle 24. The regulator assembly 118 throttles the flow of capping gas to provide the gas at a variable regulator discharge pressure. The regulator assembly 118 includes a manifold comprised of manifold portions 134,136,138,140 that present respective manifold bores 142,144,146,148. The manifold portion 134 presents opposite threaded male ends 150,152, with the lowermost end 150 being threaded into nipple 130 and sealingly engaged with one another by O-ring 154. Manifold portion 136 presents opposite threaded female and male ends 156,158, with the female end 156 receiving the male end 152 therein. Manifold portion 138 presents opposite threaded female ends 160,162, with the female end 160 receiving the male end 158 therein. Manifold portion 140 presents a threaded male end 164 that is threaded into female end 162. The manifold portion 134 presents ports 166,168,170,172 and manifold portion 138 presents ports 174,176.

The regulator assembly 118 further includes a pressure gauge 178 fluidly communicating with and received by port 168. The regulator assembly 118 also includes burst disk assemblies 180,182 threaded into and fluidly communicating with ports 166 and 172, respectively. Yet further, the regulator assembly 118 includes a check valve 184 threaded into and fluidly communicating with port 170, with the check valve 184 serving as a fill port.

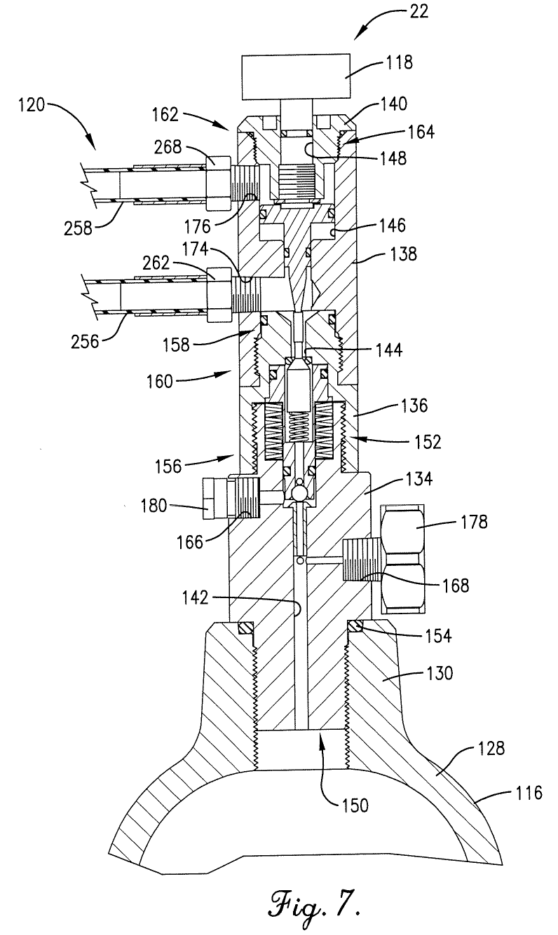

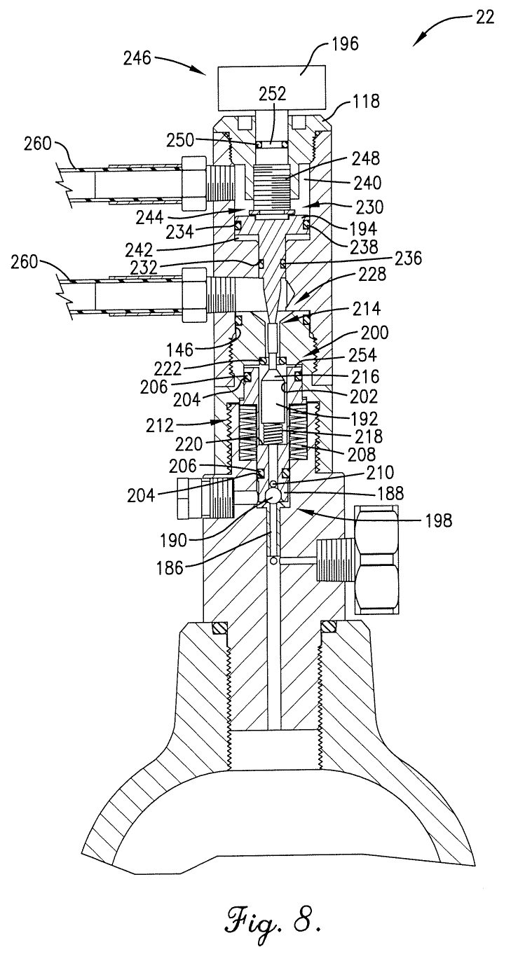

The regulator assembly 118 includes a number of components that cooperatively provide the regulated discharge pressure of the capping gas. The regulator assembly 118 includes an orifice nozzle 186, a lower piston 188, a spherical plug 190, a pin 192, an upper piston 194, and a valve screw 196. The orifice nozzle 186 is received within bore 142 and cooperates with the lower piston 188 to throttle the capping gas flow as will be discussed further. The lower piston 188 presents piston ends 198,200, an axial bore 202, and O-ring glands 204 that receive O-rings 206. The lower piston 188 is received within the bores 142,144 and is axially shiftable therein between open and closed piston positions. Belleville washers 208 are positioned in the annulus formed between the lower piston 188 and the bore 142 and serve to bias the lower piston 188 upwardly into the open position. Spherical plug 190 is received within the lower piston end 198 and serves to close the nozzle 186 when the piston 188 shifts from the open position (see FIG. 7) to the closed position (see FIG. 8). Transverse bore 210 fluidly interconnects the axial bore 202 and bore 142 so that fluid flowing past the nozzle 186 is operable to flow into the axial bore 202.

The pin 192 is generally cylindrical and unitary and presents opposite ends 212,214, with a conical sealing surface 216 spaced therebetween. The pin 192 is received within bores 142,144,146 with the lower end 212 being received within axial bore 202. A spring 218 is also received within axial bore 202 and spaced between the lower end 212 and an internal surface 220 of the lower piston 188. Similar to the lower piston 188, the pin 192 is shiftable in an axial direction between open and closed pin positions. When the regulator is deactivated, the pin 192 and manifold portion 136 are positioned in sealing engagement by the inclusion of O-ring 222 within bore 146, with the O-ring 222 engaging the conical sealing surface 216 and bore 146 (see FIG. 7). When the regulator is activated, the pin 192 is spaced axially apart from the O-ring 222 to permit fluid flow from the axial bore 202 into the bore 146 (see FIG. 8).

Upper piston 194 is a unitary and generally cylindrical member that presents opposite ends 228,230 and presents O-ring glands 232,234. The upper piston 194 is shiftably positioned within bore 148, with the end 228 engaging the pin 192. O-rings 236,238 are received in respective glands 232,234 and sealingly engage respective surfaces of the bore 148. The upper piston 194 is shiftable between engaged and disengaged piston positions. In the engaged position, the upper piston 194 is shifted into a lowermost position wherein the pin 192 is shifted into the open pin position (see FIG. 8). In the disengaged position, the upper piston 194 is shifted upwardly so that the pin 192 is permitted to shift into the closed pin position (see FIG. 7). The upper end 230 comprises a piston that sealingly engages the bore 148 to divide the bore 148 into upper and lower chambers 240,242, as will be discussed further.

The valve screw 196 is cylindrically shaped and presents opposite ends 244,246 and a threaded portion 248 spaced therebetween. The valve screw 196 is threadedly received within the manifold portion 140. An O-ring 250 is received within a corresponding O-ring gland 252 of the valve screw 196 to create a seal between the valve screw 196 and the manifold portion 140. The lower end 244 is configured to engage the upper end 230 of the upper piston 194. Rotational movement of the valve screw 196 causes axial movement of the valve screw 196 between regulator-activating and regulator-deactivating positions. In the regulator-activating position, the valve screw 196 is threaded into a lowermost position that shifts the upper piston 194 and pin 192 downwardly (see FIG. 8). In the regulator-deactivating position, the valve screw 196 is threaded into an uppermost position that permits the upper piston 194 and pin 192 to shift upwardly (see FIG. 7).

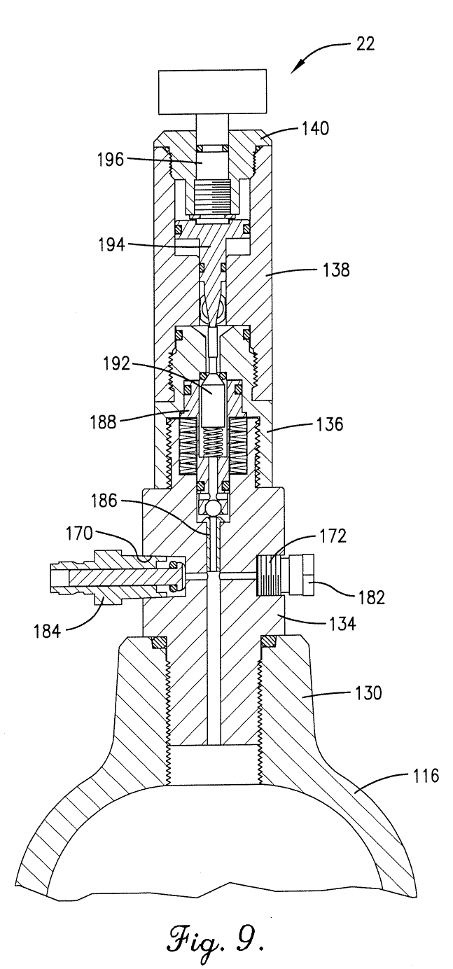

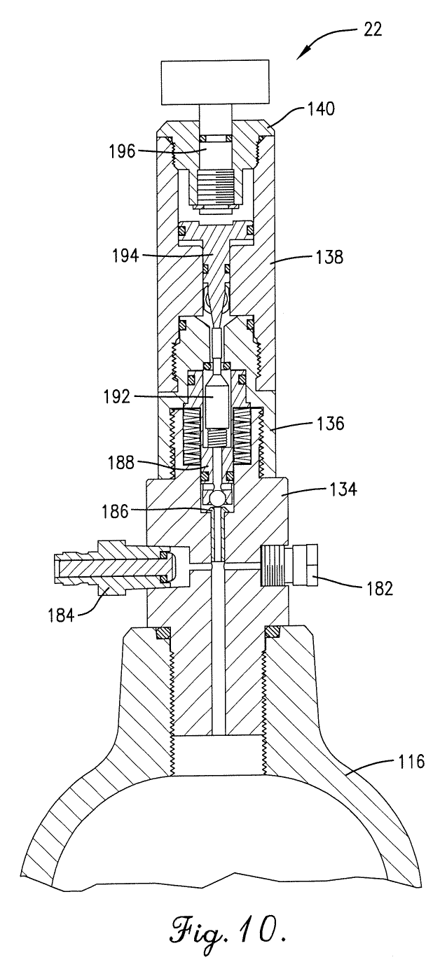

The illustrated regulator assembly 118 includes an activated condition (see FIGS. 8 and 10) and a deactivated condition (see FIGS. 7 and 9). In the deactivated condition, the valve screw 196 is in the uppermost regulator-deactivating position, which permits the upper piston 194 and pin 192 to be biased by the spring 218 into their respective uppermost positions, with the pin 192 being positioned in sealing engagement with the manifold portion 136 to prevent fluid flow out of the regulator assembly 118. Furthermore, the regulator assembly 118 can remain in the deactivated condition as long as a regulator-activating fluid pressure is not applied to the upper chamber 240, as will be discussed further.

In the activated condition, the upper piston 194 and pin 192 are forced downwardly into respective lowermost positions so that the pin 192 is unseated from sealing engagement with the manifold portion 136. The activated condition can be enabled by the valve screw 196 being shifted into the lowermost open position (see FIG. 8). Alternatively, the activated condition can be enabled by introducing pressurized fluid through the port 176 and into the upper chamber 240 at the regulator-activating fluid pressure. In this manner, force generated by pressure in the upper chamber 240 overcomes force generated by pressure in the lower chamber 242 and urges the upper piston 194 into the lowermost position.

The lower piston 188 shifts between open and closed piston positions, as discussed previously, and thereby serves to regulate fluid flow through the regulator assembly 118 when in the open condition. In greater detail, a gap is defined between an end surface 254 presented by the piston end 200 and an opposing surface presented by the bore 144. Pressure within the axial bore 202 is also present within the gap and acts against the end surface 254 to urge the lower piston 188 downwardly against the force of the washers 208 and against capping gas pressure supplied from the capping gas bottle 116 and applied to the piston end 198. When the bore pressure decreases to a predetermined regulator discharge pressure, the generally upward spring force applied by the washers 208 and the force applied to the piston end 198 by the capping gas supply pressure force the lower piston 188 to shift upwardly so that the plug 190 becomes unseated from the nozzle 186 to permit fluid flow into the axial bore 202. Continued flow into the axial bore 202 raises the bore pressure until the bore pressure reaches the predetermined regulated discharge pressure. Any additional pressure applied to the end surface 254 and to the internal surface 220 results in a downward force that urges the lower piston 188 back towards seated engagement with the nozzle 186. Thus, lower piston 188 oscillates within the regulator assembly 118 to provide a substantially constant discharge pressure at a corresponding nitrous oxide flow rate, provided that the capping gas supply pressure is at least as much as the discharge pressure.

The regulator assembly 118 preferably provides a variable-size orifice that is cooperatively formed by the nozzle 186 and the lower piston 188. The nozzle 186 presents an opening with a fixed diameter that is preferably about 0.060 inches. However, the lower piston 188 is shiftable between the open position (see FIG. 7) and the closed position (see FIG. 8), with a total axial displacement or stroke therebetween of about 0.040 inches to provide the variable-size orifice. The variable-size orifice enables the regulator assembly 118 to preferably operate as a variable-flow regulator.

Preferably, the illustrated regulator assembly 118 is a direct acting gas regulator manufactured by Pressure Specialist, Inc., 186 Virginia Road, Crystal Lake, Ill., 60014-7904. Additional preferred details of the illustrated regulator are disclosed in issued U.S. Pat. No. 7,059,343, issued Jun. 13, 2006, entitled DIRECT ACTING GAS REGULATOR, which is hereby incorporated by reference herein. While the above-referenced regulator is preferred, it is consistent with the principles of the present invention to use another regulator that controls the flow of capping gas.

Turning to FIGS. 2, 5, 7, and 8, lines 120 fluidly interconnect the regulator assembly 118 and the nitrous valve assembly 26. Lines 120 comprise a capping gas supply line 256 and a nitrous bleed line 258. Both lines 256,258 include a fluid conduit 260 that is configured to hold pressurized fluid therein. The capping gas supply line 244 includes a threaded swaged fitting 262 attached to one end of the fluid conduit 260, a conical swaged fitting 264 attached to the other end of the fluid conduit 260, and a threaded nut 266. The nitrous bleed line 258 includes a threaded swaged fitting 268 attached to one end of the fluid conduit 260 and a quick connect fitting 270 attached to the other end of the fluid conduit 260.

The capping gas supply line 256 is fluidly connected to the regulator assembly 118 by threading the threaded swaged fitting 262 into port 174. The conical swaged fitting 264 is brought into contact with valve fitting 92 and is secured in sealing engagement thereto by threading the nut 266 onto the fitting 92. Thus, capping gas is operable to be discharged by the regulator assembly 118 at the predetermined discharge pressure through the supply line 256, then through the check valve 40, and into the nitrous bottle 24.

The fitting 92 presents an axially extending vent groove 272 that divides the threads 274 of the fitting 92. The nut 266 and vent groove 272 cooperatively form a vent. As the nut 266 is being removed from the fitting 92 and the conical swaged fitting 264 is spaced from the fitting 92, pressurized fluid within the supply line 256 is permitted to pass through the vent. In this manner, the vent restricts line pressure from inadvertently and possibly violently separating the supply line 256 from the fitting 92 when the nut 266 is entirely removed from the fitting 92.

The nitrous bleed line 258 is fluidly connected to the regulator assembly 118 by threading the threaded swaged fitting 268 into port 176. The quick connect fitting 270 is removably attached to the control check valve 42. Specifically, the quick connect fitting 270 includes, among other things, a housing 274, a shiftable plug 276 that shifts within the housing 274, and a spring 278 that biases the plug 276 into an outermost closed position (see FIG. 5a). When the quick connect fitting 270 is attached to the control check valve 42, the piston plug 106 engages the plug 276, with the plug 276 shifting inwardly within the housing 274 to permit fluid flow through the bleed line 258. Also, the plug 264 shifts the piston plug 106 into an open position to permit nitrous oxide flow through the check valve 42. In this manner, the check valve 42 generally only permits nitrous oxide flow therethrough when the quick connect fitting 270 is attached to the check valve 42. In other words, the check valve 42 prevents flow therethrough when the nitrous bleed line 258 is not attached.

As previously mentioned, the bottles 24,116 are sized relative to one another in order to provide a uniform flow of nitrous oxide at a substantially constant flow rate. Preferably, the bottles 24,116 have a nitrous-to-auxiliary bottle volume ratio in the range from about 3.4:1 to about 3.6:1. More preferably, the bottles 24,116 are sized to provide the following amounts of nitrous oxide:

TABLE 3

| Amount | Nitrous Bottle Volume (cubic | Capping Gas Bottle |
|---|---|---|
| of N2O (pounds) | inches) | Volume (cubic inches) |
| 5 | 203.5 | 60 |
| 10 | 407 | 114 |
| 15 | 530 | 148 |
| 20 | 815 | 230 |

It has been determined that these particular relationships unexpectedly provide optimum nitrous system performance under variable conditions, e.g., a substantially constant nitrous oxide flow rate.

The bottles 24,116 also preferably have an auxiliary-to-nitrous bottle fill pressure ranging from about 2:1 to about 6:1. More preferably, the nitrous bottle 24 is filled to a pressure of about 1140 psi and the capping gas bottle 116 is filled to a pressure of about 4500 psi. When the filled bottles 24,116 are fluidly connected to one another by supply line 256, the pressures settle to static fill pressures of about 1100 psi for the nitrous bottle 24 and about 4000 psi for the capping gas bottle 116.

Furthermore, the bottles 24,116 preferably have an energy relationship with one another under the fill condition so that a capping gas enthalpy portion (defined by the product of the capping gas pressure and capping gas volume) is at least as much as a nitrous oxide enthalpy portion (defined by the product of the nitrous oxide pressure and the nitrous oxide volume). This relationship may occur even where the bottle 116 contains less total energy than the nitrous bottle 24 under the fill condition. More preferably, the energy relationship is configured so that the capping gas enthalpy portion is at least as much as the sum of the nitrous oxide enthalpy portion and another enthalpy portion (defined by the product of the nitrous oxide pressure and the capping gas volume). Also, the total energy ratio of the nitrous bottle 24 to the capping gas bottle 116 is preferably in the range from about 10:1 to about 100:1. These energy relationships enable the capping gas bottle 116 to supply enough capping gas to empty the nitrous bottle 24 of substantially all of the nitrous oxide that existed in a liquid phase during the fill condition.

The energy relationship also enables a substantially constant nitrous oxide flow rate. In particular, it is believed that maintaining the liquid nitrous oxide in the liquid phase permits the system 10 to provide the constant nitrous oxide flow rate. Furthermore, the liquid phase portion of the nitrous oxide is believed to be maintained in the liquid phase by maintaining the total energy of the liquid phase portion substantially constant as the nitrous oxide evacuates the nitrous bottle 24. However, for some aspects of the present invention, the principles of the present invention are applicable where the constant flow rate is provided while maintaining the liquid portion in a liquid phase independent of the total energy of the liquid nitrous oxide portion.

The illustrated system 10 is preferably configured to provide the nitrous oxide flow without the use of a bottle heater. However, the principles of the present invention are equally applicable where a bottle heater is used with the illustrated capping gas arrangement to raise the pressure within the nitrous bottle 24 or within the capping gas bottle 116. Furthermore, it is within the ambit of the present invention to use other external sources of heat to raise nitrous pressure or capping gas pressure. For example, either of the bottles 24,116 could be positioned adjacent the engine 12 so that engine exhaust is configured to supply heat thereto.

The configuration of bottles 24,116 as discussed above also permits the system 10 to supply a substantially constant flow rate of nitrous oxide until the liquid nitrous oxide is evacuated from the nitrous bottle 24. For example, the ten (10) pound nitrous oxide bottle system shown in Table 3 is able to supply a substantially constant flow rate of up to about 0.5 pounds/second of nitrous oxide to engine 12. For a stoichiometric air-to-fuel ratio of about 5.2:1, the 0.5 pounds/second flow rate provides about additional 500 horsepower. While the illustrated embodiment discloses the use of a single capping gas bottle 116 and regulator assembly 118, the principles of the present invention are also applicable where more than one capping gas bottle 116 and regulator assembly 118 are fluidly connected to the nitrous bottle assembly 20. For example, where the user requires additional horsepower, e.g., 1000 horsepower, a pair of capping gas bottle and regulator assemblies can be used with the nitrous bottle assembly 20 to supply up to double the amount of the maximum nitrous oxide flow rate, i.e., 1.0 pounds/second.

The illustrated system 10 is configured to supply nitrous oxide to engine 12 by fluidly connecting the nitrous bottle assembly 20 and the gas capping assembly 22 as discussed above. Nitrous oxide is provided to nozzles (not shown) in the intake manifold 16 by turning on the nitrous valve assembly 26 to allow nitrous oxide to flow up to a solenoid-operated valve (not shown). The gas capping assembly 22 provides capping gas to the nitrous bottle assembly 20 by turning on the regulator assembly 118, e.g., by turning the valve screw 196 (see FIG. 8) and thereby opening the regulator assembly 118. On the other hand, the automatic opening and closing function provided by the upper piston 194 is also configured to open the regulator assembly 118 (assuming the valve screw 196 is already in its regulator-activating position). Specifically, when the nitrous valve assembly 26 is turned on, nitrous oxide passes through bleed bore 64, through the control check valve 42, through the bleed line 258, and into upper chamber 240. The pressure associated with the nitrous oxide forces the upper piston 194 downwardly to activate the regulator assembly 118. Thus, turning on the nitrous valve assembly 22 automatically activates the regulator assembly 118. Similarly, turning off the nitrous valve assembly 22 permits the engine 12 to use the remaining nitrous oxide within the bleed bore 64, which reduces the bleed pressure and encourages the upper piston 194 to return to the uppermost position provided that the valve screw 196 is positioned in the uppermost position.

As mentioned previously, the capping gas bottle 116 is operable to contain compressed capping gas therein, such as an oxygenic capping gas, e.g., compressed nitrous oxide, Nitrox, or HPA. As nitrous oxide flows through the siphon tube 38 out of the nitrous bottle 24 to the engine 12, the regulator assembly 118 allows capping gas to flow through the supply line 256, through the check valve 40 and into the nitrous bottle 24. It has been observed that the flow of nitrous oxide out of the bottle 24 and the flow of high pressure capping gas into the bottle 24 often creates a turbulent mixing condition between the liquid and vapor phases. This mixing of the liquid and vapor phases causes vapor, either nitrous oxide vapor or capping gas, to become entrained within the liquid phase as it flows into the siphon tube 38 and out of the bottle 24. However, it has also been observed that providing HPA as the capping gas at a pressure of about 1100 psi to the nitrous bottle 24 limits the amount of capping gas that becomes entrained within the liquid nitrous oxide. Entrained vapor can be introduced with the liquid nitrous oxide into the engine 12 and can either promote or inhibit combustion. Where nitrogen is used as a capping gas, entrained nitrogen vapor may inhibit combustion because nitrogen is generally not a combustion reactant. On the other hand, an oxygenic capping gas, such as HPA or Nitrox, includes oxygen that serves as a combustion reactant.

The system 10 operates to provide a substantially constant nitrous oxide flow rate to the engine 12. As nitrous oxide begins to flow out of the bottle 24, the nitrous bottle operating pressure begins to drop from the initial fill pressure of about 1100 psi. As the operating pressure drops, the regulator discharge pressure drops accordingly, which causes the regulator assembly 118 to discharge capping gas into the bottle 24. It is believed that the capping gas flow causes the operating pressure to stabilize and approach a constant value. For the illustrated system 10, the nitrous bottle operating pressure will approach a substantially constant pressure in the range of about 780 psi to about 950 psi. This occurs because flow losses within the system 10 cause the nitrous operating pressure to vary inversely with the capping gas flow rate. In other words, a low capping gas flow rate results in a high nitrous bottle operating pressure while a high capping gas flow rate results in a low nitrous bottle operating pressure.

The illustrated regulator assembly 118 provides a variable-flow regulator that cooperates with the remainder of the system 10 to provide the substantially constant nitrous oxide flow rate. In particular, the regulator assembly 118 provides a variable-size orifice that is cooperatively formed by the nozzle 186 and the lower piston 188 as previously discussed. Again, the nozzle 186 presents an opening with a fixed diameter that is preferably about 0.060 inches, with the lower piston 188 being shiftable between the open position (see FIG. 7) and the closed position (see FIG. 8) to provide the variable-size orifice.

The regulator assembly 118 provides a variable capping gas flow. The regulator assembly 118 preferably varies the gas flow in response to changing system conditions, e.g., initiation of nitrous flow, ambient temperature change, or other inputs that change the pressure and temperature of the nitrous oxide within the bottle 24. It has been unexpectedly observed that the ability of the regulator assembly 118 to vary the capping gas flow in response to changing system conditions enables the system 10 to provide a substantially constant nitrous oxide flow rate during substantially the entire time that liquid nitrous oxide is evacuating the nitrous bottle 24.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A nitrous oxide injection system operable to supply an enhanced oxygen flow to a combustion engine, said system comprising:
a nitrous bottle containing compressed nitrous oxide configured to provide the enhanced oxygen flow, with at least part of the nitrous oxide being in a liquid phase;
an auxiliary bottle containing a compressed oxygenic capping gas; and
a capping gas regulator that fluidly interconnects the bottles and regulates flow of capping gas from the auxiliary bottle to the nitrous bottle so that the capping gas flow maintains a total energy within the nitrous bottle while the nitrous bottle supplies the oxygen flow to thereby keep substantially all of the liquid phase portion in the liquid phase as the nitrous oxide evacuates the nitrous bottle.

2. The nitrous oxide injection system as claimed in claim 1,
said liquid phase portion having a liquid total energy that remains substantially constant as the nitrous oxide evacuates the nitrous bottle.

3. The nitrous oxide injection system as claimed in claim 1; and
a nitrous bottle valve assembly fluidly connected to the nitrous bottle and presenting a port that fluidly communicates with the bottles,
said nitrous bottle valve assembly including a check valve fluidly connected to the port, with the check valve permitting one-way flow of capping gas into the nitrous bottle through the port and preventing nitrous oxide from flowing out of the nitrous bottle through the port.

4. The nitrous oxide injection system as claimed in claim 3; and
a conduit fluidly connecting the check valve and the auxiliary bottle,
said check valve including a housing that is removably attached to the conduit,
said conduit and housing cooperatively presenting a vent that is closed while the conduit and housing are attached to one another in a sealed vent condition,
said housing and conduit cooperatively providing an unsealed vent condition during detachment of the housing from the conduit, wherein the vent is open.

6. The nitrous oxide injection system as claimed in claim 1,
said auxiliary bottle having less total energy than the nitrous bottle prior to supply of the enhanced oxygen flow.

7. The nitrous oxide injection system as claimed in claim 6,
said bottles defining a nitrous-to-auxiliary bottle total energy ratio in the range from about 10:1 to about 100:1.

8. The nitrous oxide injection system as claimed in claim 1,
said compressed oxygenic capping gas being selected from the group consisting of high pressure air, nitrous oxide, Nitrox, and combinations thereof.

9. The nitrous oxide injection system as claimed in claim 1,
said bottles presenting corresponding internal volumes,
said bottles being operable to contain the corresponding one of the nitrous oxide and capping gases at respective filled pressures, wherein a capping gas enthalpy portion defined by the product of the capping gas pressure and capping gas volume is at least as much as a nitrous oxide enthalpy portion defined by the product of the nitrous oxide pressure and the nitrous oxide volume.

10. The nitrous oxide injection system as claimed in claim 9,
said capping gas enthalpy portion being at least as much as the sum of the nitrous oxide enthalpy portion and another enthalpy portion defined by the product of the nitrous oxide pressure and the capping gas volume.

11. The nitrous oxide injection system as claimed in claim 9,
said bottles defining an auxiliary-to-nitrous bottle filled pressure ratio in the range from about 2:1 to about 6:1.

12. The nitrous oxide injection system as claimed in claim 11,
said nitrous bottle filled pressure being about 1100 psi.

13. The nitrous oxide injection system as claimed in claim 11,
said auxiliary bottle pressure being about 4000 psi.

14. The nitrous oxide injection system as claimed in claim 9,
said nitrous bottle having at least about twice the volume of the auxiliary bottle.

15. The nitrous oxide injection system as claimed in claim 14,
said bottles defining a nitrous-to-auxiliary bottle volume ratio in the range from about 3.4:1 to about 3.6:1.

16. The nitrous oxide injection system as claimed in claim 14,
said nitrous bottle volume being selected from the group consisting of about 203.5 cubic inches, about 407 cubic inches, about 530 cubic inches, and about 815 cubic inches.

17. The nitrous oxide injection system as claimed in claim 14,
said auxiliary bottle volume being selected from the group consisting of about 60 cubic inches, about 114 cubic inches, about 148 cubic inches, and about 230 cubic inches.

18. The nitrous oxide injection system as claimed in claim 1,
said pressure regulator being a variable-flow pressure regulator that is operable to discharge the capping gas flow at a substantially constant pressure,
said pressure regulator being operable to vary the capping gas flow so that the system provides a substantially constant nitrous oxide flow from the nitrous bottle until all of the liquid phase portion is evacuated.

19. A nitrous oxide injection system operable to supply enhanced oxygen flow to a combustion engine, said system comprising:
a nitrous bottle containing compressed nitrous oxide configured to provide the enhanced oxygen flow, with at least part of the nitrous oxide being in a liquid phase;
an auxiliary bottle containing a compressed capping gas; and
a variable-flow pressure regulator that fluidly interconnects the bottles and regulates flow of capping gas from the auxiliary bottle to the nitrous bottle,
said variable-flow pressure regulator being operable to discharge the capping gas flow to maintain substantially all of the liquid phase portion in the liquid phase while the nitrous bottle supplies the oxygen flow,
said pressure regulator being operable to vary the capping gas flow so that the system provides a substantially constant nitrous oxide flow rate from the nitrous bottle until all of the liquid phase portion is evacuated,
said variable-flow pressure regulator including regulator elements that cooperatively form a variable-size regulator orifice to control the capping gas flow through the orifice when open.

20. The nitrous oxide injection system as claimed in claim 19,
said variable-flow pressure regulator providing the capping gas flow so that the nitrous tank has a nitrous tank operating pressure that is inversely proportional to the nitrous oxide flow rate, with the nitrous tank operating pressure being in the range from about 780 psi to about 950 psi.

21. The nitrous oxide injection system as claimed in claim 19,
said variable-flow pressure regulator providing the capping gas flow so that the substantially constant nitrous oxide flow rate can range up to about 0.5 lbs/second.

22. The nitrous oxide injection system as claimed in claim 19,
said bottles defining a nitrous-to-auxiliary bottle volume ratio in the range from about 3.4:1 to about 3.6:1.

23. The nitrous oxide injection system as claimed in claim 19,
said regulator elements comprising a nozzle and a nozzle-covering element,
said nozzle-covering element being shiftable into and out of a closed orifice position wherein the nozzle-covering element engages the nozzle,
said nozzle-covering element being shiftable up to about 0.040 inches away from the nozzle to provide the variable-size orifice.

24. A method of injecting nitrous oxide from a nitrous bottle into a combustion engine, with at least part of the nitrous oxide being in a liquid phase, said method comprising the steps of:
(a) fluidly connecting a capping gas bottle to the nitrous bottle;
(b) opening the nitrous bottle to permit the flow of nitrous oxide into the engine; and
(c) transmitting oxygenic capping gas from the capping gas bottle to the nitrous bottle while supplying the nitrous oxide to the engine,
step (c) including the step of maintaining an amount of total energy within the nitrous bottle while the nitrous bottle supplies the oxygen flow so that substantially all of the liquid phase portion is maintained in the liquid phase as the contained nitrous oxide evacuates the nitrous bottle.

25. The method as claimed in claim 24,
step (c) including the step of maintaining an amount of liquid total energy of the liquid phase portion substantially constant as the contained nitrous oxide evacuates the nitrous bottle.
